(19) United States
(12) Patent Application Publication
(10) Pub. No.: US 2008/0249655 A1
(43) Pub. Date: Oct. 9, 2008

(54) Recycle station layout and system

(75) Inventors: Michael Wadden, Paradise (CA); Jonathon Drover, St. John's (CA); Kurt W. Williams, St. John's (CA)

Correspondence Address: Emerson, Thomson & Bennett, LLC, 777 W. Market Street, Akron, OH, 44303, US

(73) Assignee: EVER GREEN ENVIRONMENTAL CORPORATION, ST. JOHN'S (CA)

(21) Appl. No.: 12/080,632

(22) Filed: Apr. 4, 2008

(30) Foreign Application Priority Data
Apr. 4, 2007 (CA) 2583955

(51) Int. Cl. B07C 5/00; G06F 7/00

(52) U.S. Cl. 700/213; 209/522

(57) ABSTRACT

A receiving, sorting/counting station arrangement for recycling of beverage and food containers, comprises one or more spaced sorting tables for use by sorters, the sorting tables being aligned adjacent and on one side of an elongated customer beverage and food container reception table, the space between the sorting tables providing space for shipping bags for sorted beverage and food containers.

### FIELD OF THE INVENTION

This application claims priority to Canadian Patent Application No. 2,583,955, filed Apr. 4, 2007, which is hereby incorporated by reference. The present invention relates to a receiving/sorting/counting station arrangement and system for the recycling of beverage and food containers.

### BACKGROUND OF THE INVENTION

As landfill garbage sites become increasingly filled, and as recycling of used items, such as beverage containers, becomes more popular and necessary, government and private organizations are becoming more active in promoting recycling programs. Many jurisdictions in North America, such as the provinces of Newfoundland and Alberta in Canada, actually operate province-wide deposit-return systems for the recovery and recycling of many types of beverage containers, such as aluminum cans, plastic and glass bottles, poly-coat containers (for instance for fruit juices), bi-metal containers and steel beverage cans. The consumer is paid a “refund” depending on the number and types of units of such containers returned to a recycling depot.

Conventionally, such recycling depots have not been well organized. Often consumers, returning containers, drop the containers off at tables where sorter workers are working to sort the containers. The sorters sort the collected containers, according to type, usually into large shipping bags for subsequent shipping to companies specializing in recycling of particular types of containers. Besides resulting chaos and customer and worker safety issues created by intermingling of customers and workers in such depots, other problems including worker stress because of difficult working conditions, low productivity and beverage container count errors can arise. As well, the height of the sorting table is not adjustable and the large surface area of the sorting table means extended reaching for the sorters. Moreover, each sorter has to count every recyclable container and throw those recyclable containers into the appropriate one of multiple storage containers. Usually the containers are not labeled and have no set location in the sorting area of the depot.

While prior art references teach specific layouts for, for example, stores (U.S. Pat. No. 4,154,027 of Searcy, issued May 15, 1979), restaurants (U.S. Pat. No. 4,274,233 of Currier, issued Jun. 23, 1981) and warehouses (U.S. Pat. No. 5,371,679 of Abe et al., issued Dec. 6, 1994), little prior art exists with respect to layouts for recycling depots. One reference of background interest is Canadian Patent No. 2,373,254 issued Jul. 26, 2005, which describes and illustrates a sorting and separating method for recycling of plastics.

It is an object of the present invention to provide a sorting/counting workstation and system for sorters at recycling depots, which will reduce many of such problems of ergonomics, workflow, management and customer relations which have previously arisen at conventional recycling depots.

### SUMMARY OF THE INVENTION

In accordance with one aspect of the present invention there is provided a receiving, sorting/counting station arrangement for recycling of beverage and food containers. The arrangement comprises one or more spaced sorting tables for sorters, the sorting tables aligned adjacent and on one side of an elongated customer reception table for receiving thereat beverage and food containers, the space between the sorting tables providing space for shipping bags or containers for sorted beverage and food containers.

In one embodiment of the present invention, in the space between the sorting tables is one or more moveable shipping bag support frames and a shipping bag supported on each shipping bag support frame.

Another embodiment of the present invention incorporates an electronic information management system in the form of a computer terminal, associated with each workstation, the computer terminal adapted to receive and store information inputted by a corresponding sorter concerning the number and type of recycled items received and sorted by that sorter at the corresponding sorting table.

As will be discussed in more detail subsequently, the sorting station according to the present invention provides improved ergonomics, increased production, decreased likelihood of beverage container count errors, improved production management, and improved customer service.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the present patent specification as a whole.

### BRIEF DESCRIPTION OF THE DRAWINGS

These and other advantages of the invention will become apparent upon reading the following detailed description and upon referring to the drawings in which:

FIG. 1 is an isometric view of a receiving/sorting/counting station, for a recycling depot, in accordance with the invention;

FIG. 2 is an exploded isometric view of the sorting table of FIG. 1 illustrating further details of its construction;

FIG. 3 is an isometric view of a shipping bag holder for use in association with the sorting table of FIG. 1;

FIG. 4 is a schematic network diagram illustrating how workers at a recycle depot and other recycle depots, in accordance with the present invention, can communicate and exchange information with a central management site;

FIG. 5 is an illustration of a program product and associated modules according to an embodiment of the present invention;

FIGS. 6(a) and 6(b) is a flow chart illustrating the operations performed by the program product according to an embodiment of the present invention;

FIGS. 7-16 are views of computer display screens presented when using the program product according to an embodiment of the present invention.

The present invention will now be described by way of a non-limiting description of certain detailed embodiments.

### DETAILED DESCRIPTION OF EMBODIMENTS OF THE INVENTION

In the following description, similar features in the drawings have been given identical reference numerals where appropriate. All dimensions described or suggested herein are intended solely to illustrate an embodiment. These dimensions are not intended to limit the scope of the invention that may depart from these dimensions.

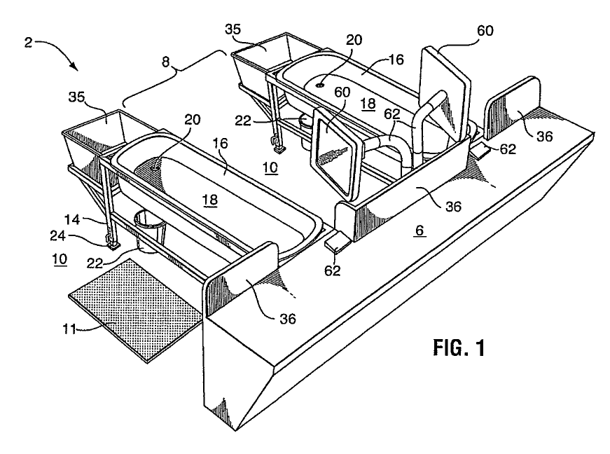

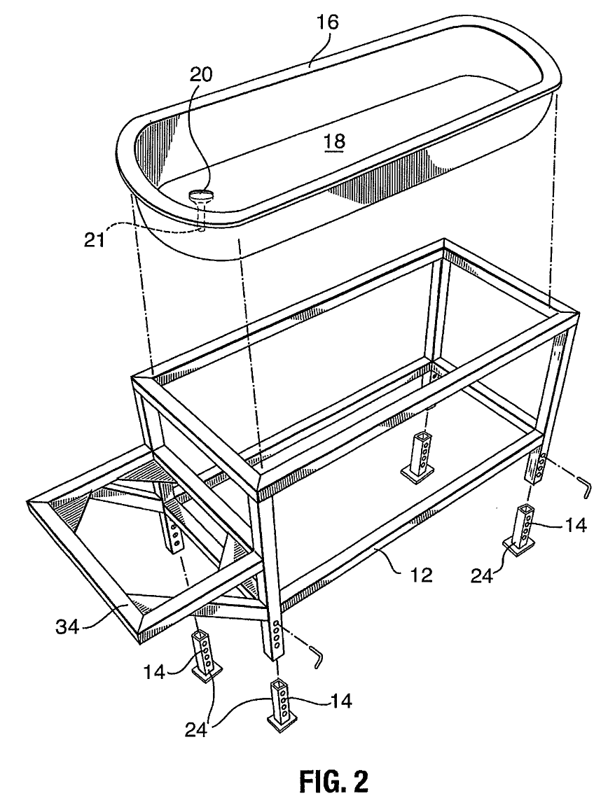

Turning to FIG. 1 there is illustrated a receiving/sorting/ counting station 2 in accordance with an embodiment of the present invention. Station 2 comprises a pair of sorting tables 4, to receive beverage and food containers to be sorted. Tables 4 are spaced from each other as illustrated and aligned adjacent and on one side of an elongated customer beverage and food container reception table 6. The space 8 between tables 4 is intended for appropriate shipping bags, as will be described in more detail subsequently herein. Sorters normally work in spaces 10 on the opposite side of tables 4 from space 8. Fatigue mats 11 may be placed on the floor area of space 10 for the comfort of the sorters.

Each sorting table 4 has a frame 12, for example made of aluminum tubing, and has generally rectangular configuration, as illustrated with legs 14. Upper portions of tubing frame 12 support a tub 16 (which may simply be a bathtub insert) the bottom 18 of which tub 16 is configured to flow collected liquid towards a drain 20, through a spigot 21 and into a bucket 22 positioned in a space under table 4, below drain 20.

Adjustment sleeves 24 are provided for the feet 26 at the bottom portions of legs 14. A number of vertically spaced and aligned apertures 28 extend from side to side across opposite portions of sleeves 24, and co-operate with similar, vertically spaced and aligned apertures 30 extending from side to side across feet 26, so that by aligning appropriate pairs of apertures 28 and 30 in corresponding sleeves 24 and feet 26, and inserting an anchor pin 32 through those aligned apertures 28, 30, on feet 26, the height of each sorting table 4 can be adjusted to a comfortable height for a sorter working at that table 4.

A horizontal end platform 34 is also provided on each sorting table 4 at the end remote from customer reception table 6. This platform 34 supports a transfer basket 35 to hold sorted heavier beverage containers, such as those made of glass. Transfer basket 35, when filled, is moved by worker to a wheeled transfer cart (not illustrated) and then, when the transfer cart is full, to an appropriate shipping bin where the transfer baskets' contents are deposited in a shipping bin (not illustrated).

To more distinctly delineate the customer area, on one side of customer table 6, and the sorter worker area on the other side, and to assist the sorters when receiving containers from customers, a vertical partition 36 may be provided along portions of the customer reception tables 6 on the side adjacent the sorting table 4, as illustrated.

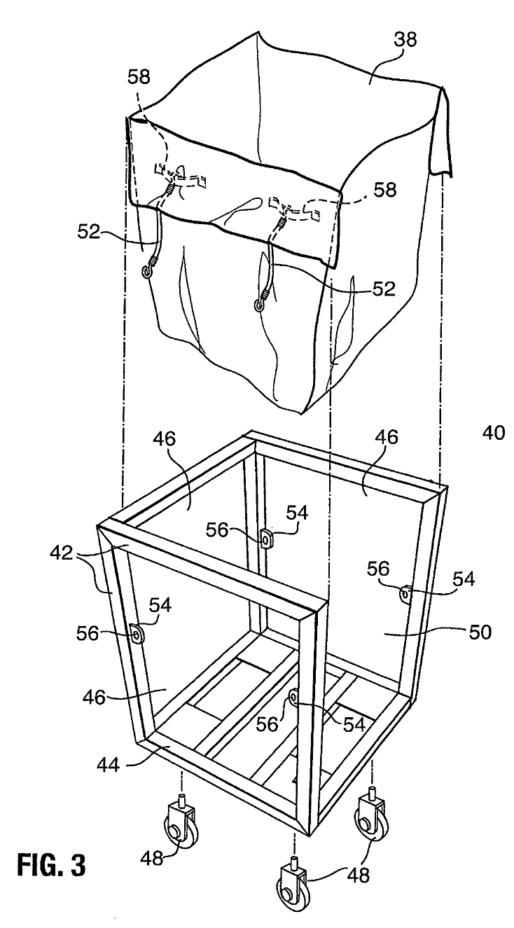

Lightweight beverage containers such as those made of aluminum or clear plastic are selectively placed by a sorter in relatively large shipping bags 38, which bags 38 are positioned adjacent each other as illustrated in space 8 between sorting tables 4. These shipping bags 38 are each held on a support frame 40, details of which are illustrated in FIG. 3. Support frame 40, as illustrated, is made up of lightweight rigid tubing 42, for example made of aluminum, this tubing 42 arranged to form a rectangular base 44 and three rectangular sides 46 upwardly extending from that base 44. Rollers 48 downwardly extend from the base 44. The three sided construction of the frame 40 provides an open side 50 for easy insertion or removal of shipping bag 38 with respect to support frame 40. Shipping bag 38, in its corresponding support frame 40, is maintained in an open position, under tensioning, by means of elasticized, bungee cords 52, the hooks of one end of which fasten to a plurality of spaced lugs 54 having apertures 56 as illustrated. The other ends of bungee cords 52 are secured to shipping bag handle straps 58. Support frames 40 conveniently hold shipping bags 30 in an open position while they are being filled, and make transporting those bags to shipping areas in the recycle depot very easy.

One or more computer display screens or monitors 60, preferably on swivel mounts 62, are provided for each sorting table 4. This display screen 60 is preferably a flat panel touch screen which is easy for sorters to use and requires less room on or beside the sorting tables 4. The display screens 60 are connected in the usual manner to a computer, such as a personal computer (PC). A card scanning device 62 is provided on the customer reception table 6 for each sorting table 4 and is connected to the PC associated with that table 4. Thus, when a regular customer arrives, the customer's “smart card” may be scanned by the scanning device 62 to access the customer's profile and then the device will be used to enter into the database exactly what the person brought into the depot. The computer will then cause a receipt to be printed so that the customer can collect his or her money or store a credit in his or her “card” account.

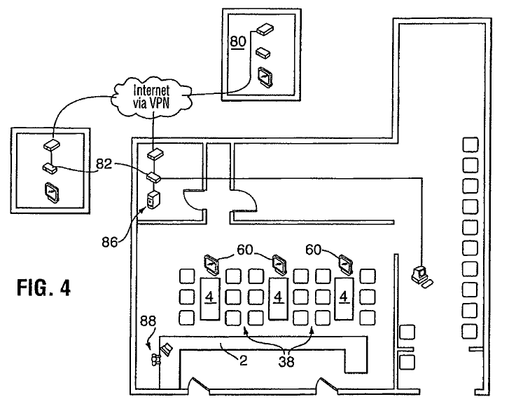

A schematic plan view of a recycle depot incorporating a plurality of receiving/sorting/counting stations 2 with a computer network in accordance with the present invention is illustrated in FIG. 4 and shows how a plurality of such stations 2 can be set up to communicate electronically with a central office 80. More particularly, a wi-fi router 82 is used to link together different recycle depots and the computer terminals 60 at the sorting tables 4 via a virtual private network (VPN). The system may also provide wireless access for pocket PCs.

A local computer server 86 is provided to hold all the system data and software and can be accessed remotely from all locations in the depot. The server 86 is provided with a backup unit built into the device and is connected to an uninterruptible power supply UPS (not illustrated).

It will be understood that the receiving/sorting/counting station 2, according to the present invention, provides significant advantages in that it 1) provides more operator comfort through improved ergonomics (to reduce operator stress), 2) allows for increased volume throughput (increase production capacity), 3) decreases the likelihood of beverage container count errors, 4) reduces non-value added activities in the overall process, 5) allows for improved production management, and 6) improves customer service by reducing chaos in the reception area and by better managing queues.

The layout includes a cashier booth 88 (FIG. 4) to be installed conveniently in the front customer reception area, at one end of the customer reception table 6. The use of electronic information management system, which includes shipping data collection as well as financial information, greatly enhances management's ability to operate the recycle depots. It is envisaged that a recycle depot according to the present invention will reduce customer service time by 50%, improve overall processing speed and increase accuracy of recycling counts. This will help to maximize the competitive position of the depot and allow it to increase its market share.

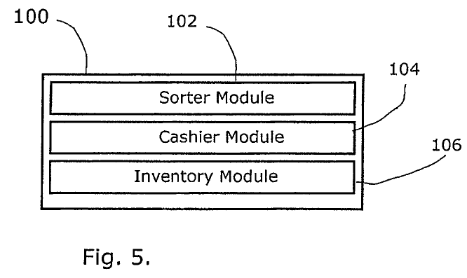

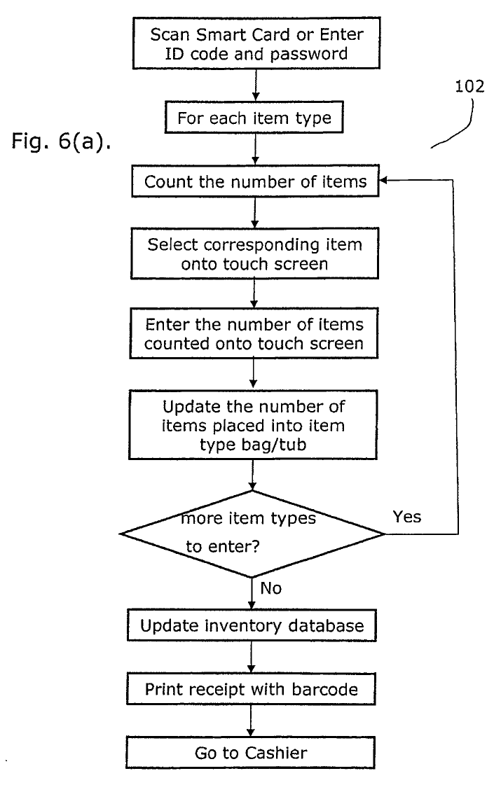

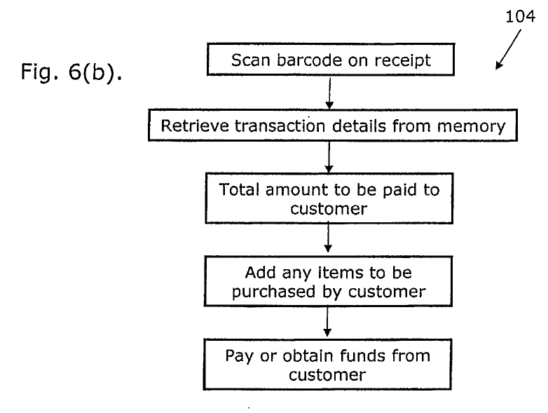

FIG. 5 diagrammatically illustrates the program product 100 and associated program modules. FIG. 6 illustrates the flow diagram of the software or program product 100 used in conjunction with computers 60 according to an embodiment of the present invention.

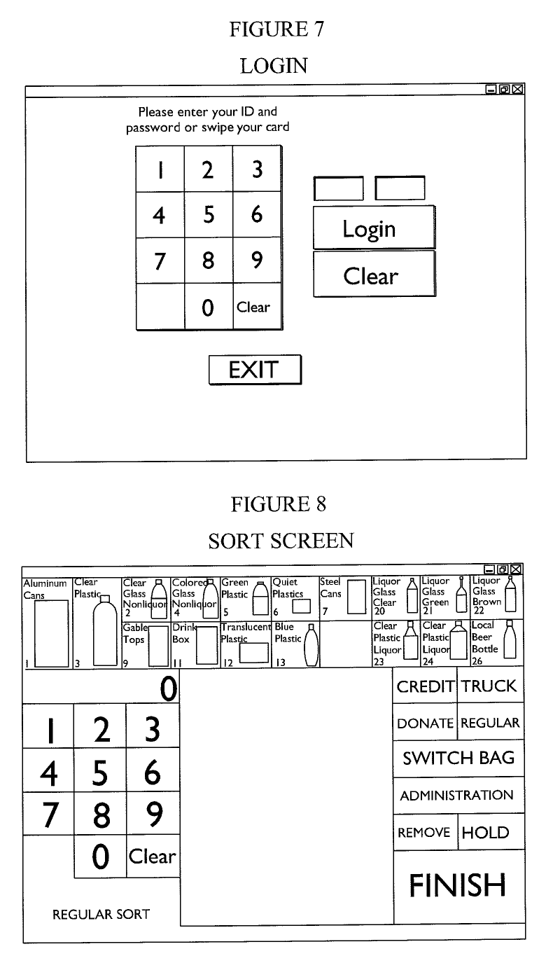

Referring to FIG. 5, the program product 100 includes sorter code 102, cashier code 104, and inventory code 106. It will be understood by those skilled in the art that the program product will include code for performing other well known tasks. Such tasks have not been described herein. In general, the program product comprises a memory having computer readable code embodied therein for execution by a computer programmable unit (CPU), for managing food and beverage item recycling. The code includes customer code responsive to either data scanned from a green card or to data entered or supplied by a customer for identifying a customer being serviced. FIG. 7 illustrates a Login screen.

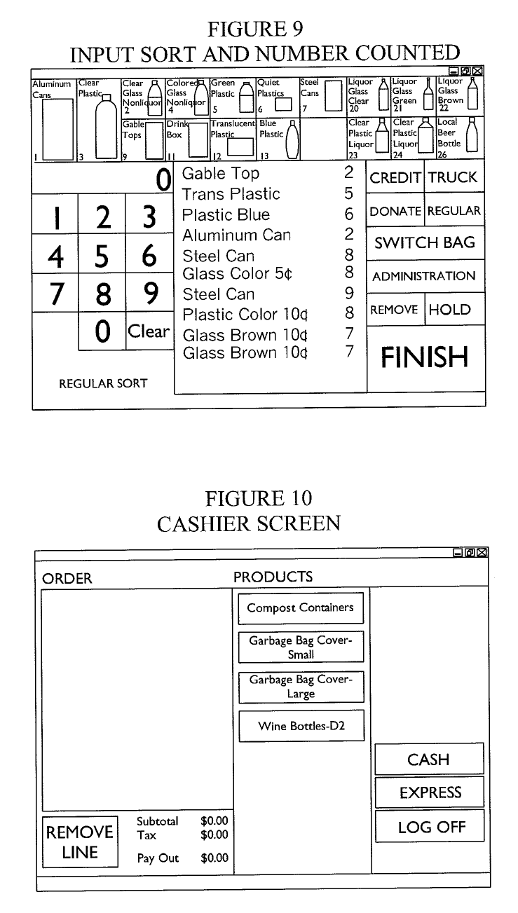

The sorter code displays screens, such as shown in FIGS. 8 and 9, on a computer monitor. The screen in FIG. 8 has a plurality of selectable food and beverage item types generally designated by reference numeral 110. The code responds to user input when a selection of one of the items is made and a number of sorted items is entered. FIG. 9 illustrates the container types and number of each entered. The code then stores and updates a count of items of the selected type which are placed in an item type container, and prints a receipt with a barcode. The sorter code has an option for switching bags, i.e., when a bag/tub is full, it is replaced by an empty bag/tub. The code generates a tag number that will be associated with the new bag or container. The code displays the tag on the screen together with the location of the new bag and causes a stick label containing the tag number to be printed. The stick label is secured to a tag which is then attached to the container.

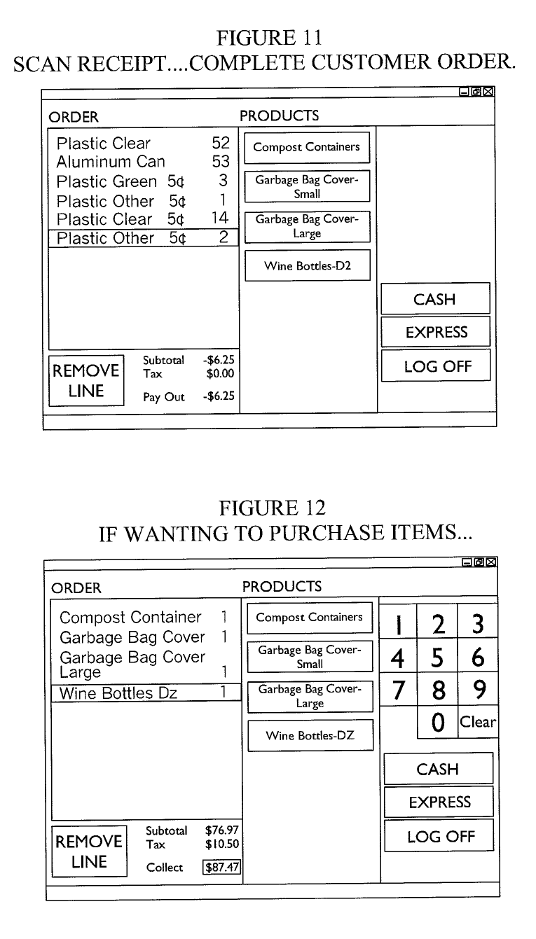

Referring to FIGS. 10-12, the cashier code reads the barcode on the receipt generated by the sorter code and extracts from memory and displays on the screen the number of all item types received from the customer. The code then totals the total cash value and the cash amount paid out to the customer. As shown in the display shown in FIG. 12, the code may also provide for the purchase of items by the customer.

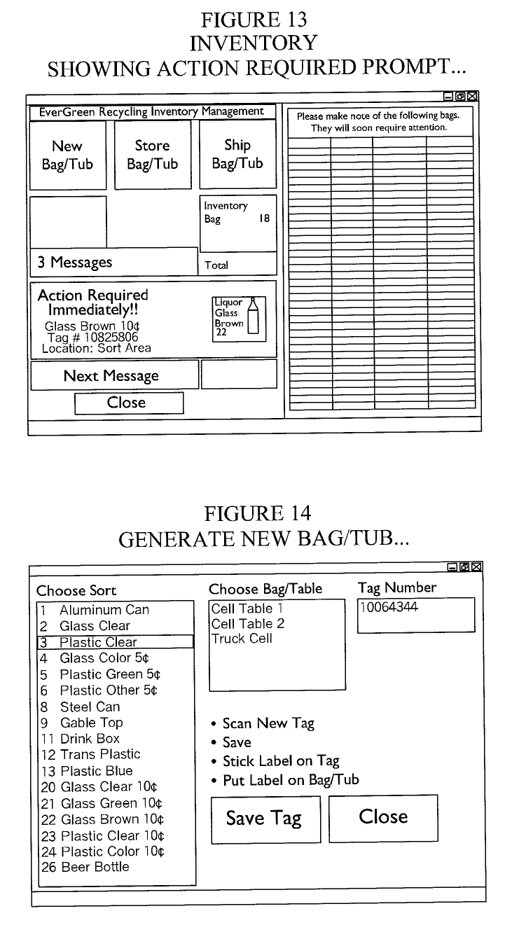

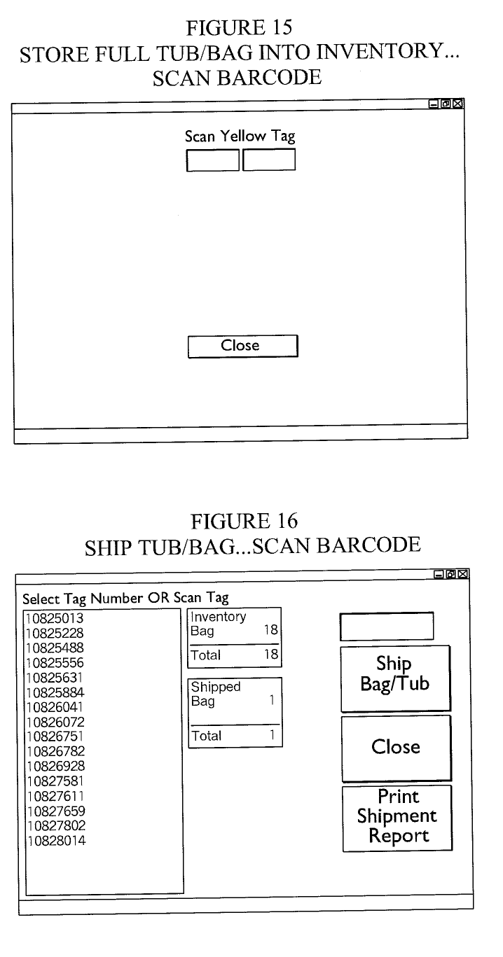

Referring to FIG. 13, which is a display of an inventory screen, the inventory code manages all item type containers, including their present location, type, the number of items in the container and the maximum number of items the container can hold. When a bag/tub is added to inventory, the Store Bag/Tub option in FIG. 13 is selected. The inventory code responds to the selection by displaying the screen of FIG. 15. The user responds by scanning the tag associated with the bag/tub. The code then responds by updating the location of the bag/tub.

In summary, it will be seen that the information system delivers a fully integrated experience from the point of sale (POS), through inventory straight to the accounting department. It meets the needs of all the customers as well as those of the staff while enabling management to improve decision making by gathering real-time facts and figures from depots and making them available throughout the enterprise.

The system starts with the latest in POS hardware technology, using barcodes, touch screens and thermal printers to ensure the customer is served as fast and accurately as possible at a sorting table. The customer can also acquire a “Green Card” (MSR Technology) to further enhance and accelerate the total experience. The cash terminal offers retail opportunities and the chance to increase revenues as well as further enhance the customer experience. The system also provides “Green Card” holders instant access through a Web-based user interface, enabling customers to access, explore, and analyze information faster and more easily than before. This reduces the load on staff as customers can now serve themselves and update their own accounts via the website.

After the product is sorted and entered in the computer once at the sorting table, made easier by touch screen computers, it goes into inventory where it awaits shipping. The inventory can be accessed at all times in real time, easing management of the inventory and shipping. The inventory system sends out digital advisories when thresholds in the inventory have been surpassed, directing staff when and how to act.

The accounting department gets day-end integration into their accounting package so the accountant can spend less time inputting data and more time analyzing data, thus saving time and money. Accountants can identify financial problems quickly before they get a chance to balloon.

The management gets real time reporting on many variables, including volume of sorts, speed of employees, POS frequency, inventory size and aging, profit, etc. Because the system works in real-time, management can act proactively to assign staffing levels, remove inventory, etc.

The system works across multiple depots through the use of a virtual private network (VPN). This allows all data to be collected in real time without duplication and with less error than the previous manual system. The VPN helps with the scalability of the system. Multiple depots can be added easily to handle growth. The system will work in one depot or will scale up to warehouse industrial levels. Overall the system reduces human error, cuts duplication, increases accuracy, boosts customer experience, raises efficiency and ultimately raises revenue and profit.

Although the present invention has been described by way of a detailed description in which various embodiments and aspects of the invention have been described, it will be seen by one skilled in the art that the full scope of this invention is not limited to the examples presented herein. The invention has a scope which is commensurate with the claims of this patent specification including any elements or aspects which would be seen to be equivalent to those set out in the accompanying claims.

We clam:

1. A receiving, sorting/counting station arrangement for recycling of associated beverage and food containers, comprising:
a pair of spaced sorting tables for sorters, the sorting tables aligned adjacent and on one side of an elongated customer beverage and food container reception table, the space between the sorting tables providing space for shipping bags for sorted associated beverage and food containers.

2. A station according to claim 1, wherein each one of the sorting tables comprises:
a frame having legs, an
a tub supported by the frame.

3. A station according to claim 2, wherein each tub has a liquid drain and is positioned and configured so as normally to flow liquid to the drain.

4. A station according to claim 2, wherein means are provided, associated with the legs, for adjusting the height of the table.

5. A station according to claim 4, wherein the adjusting means comprise:
sleeves receiving the bottom ends of the legs, the sleeves having a plurality of spaced, vertically-aligned apertures on opposite sides of the sleeves, a plurality of vertically positioned, aligned apertures being provided through the legs, the sleeves adapted to receive bottom ends of the legs and the apertures in the sleeves and legs adapted to be alignable to receive pins to hold the table at a desired height.

6. A station according to claim 2, wherein the sorting table is provided, at an end remote from the customer reception table, a platform to receive and support, at an appropriate height, a transfer basket for receiving sorted associated containers.

7. A station according to claim 1, wherein a vertical partition is provided along portions of the customer reception table on a side adjacent the sorting tables to delineate and differentiate between customer areas and sorter areas of the station.

8. A station according to claim 1 further comprising, between the sorting tables, one or more movable shipping bag support frames and a shipping bag supported on each shipping bag support frame.

9. A station according to claim 8, wherein the bag support frames comprise:
lightweight, rigid tubing forming a rectangular base;
three rectangular sides upwardly extending from the base; and,
rollers downwardly extending from the base, the frame providing an open side for easy insertion and removal of a shipping bag with respect to the support frame.

10. A station according to claim 9, wherein the bag support frame is further provided with a plurality of spaced lugs secured to sides of the frame and provided with apertures to receive elasticized cords to be connected with a bag supported within the frame, to hold the bags in an open position.

11. A station according to claim 1, wherein an electronic information management terminal is associated with each sorting table, each terminal adapted to receive and store information inputted by a corresponding sorter concerning the number and type of associated recycled items received and sorted by that sorter at the corresponding sorting table.

12. A station according to claim 11, wherein a scanner card reader is associated with each electronic information management terminal.

13. A station according to claim 11, wherein each electronic information management terminal is configured so as to communicate with a central terminal, the central terminal configured so as to receive information from multiple electronic information management terminals at the sorting tables and collect and store information necessary for management of multiple sorting tables.

14. A method of recycling beverage and food containers, comprising:
identifying a customer, having food and beverage containers, to be reimbursed;
depositing the food and beverage containers at a container sorting station;
for each type of container:
counting the number of containers;
selecting the container type from a display screen associated with a sorting station computer;
entering the number of containers counted onto the display screen;
storing the number of containers in a memory associated with the computer; and
when all containers have been processed, transferring data from the memory to a network server; and
issuing a receipt having a barcode identifying a transaction identification.

15. A method as defined in claim 14, further including:
submitting the receipt to a cashier;
reading the barcode transaction identification on the receipt;
retrieving transaction data from the network server;
compensating the customer for the food and beverage containers received; and
updating cashier funds in the local network server.

16. A method as defined in claim 14, further including:
for each container type,
depositing each container in a corresponding item type container; and
updating a count of the number of containers placed in the type container in the memory.

17. A method as defined in claim 16, further including:
when any item type container is filled,
moving the item type to inventory;
updating inventory memory;
replacing the filled item type container with a new container, including:
generating and saving a container identification for the new container;
generating a label with the container identification; and,
applying the label to the new container.

18. A computer readable medium containing instructions for controlling a computer system to perform a method for managing food and beverage item recyclying, the method comprising:
providing customer code responsive to either data scanned from a green card for identifying a customer being serviced;
displaying a screen on a monitor having a plurality of selectable food and beverage item types which can be recycled;
responding to user input for selecting one of the items;
entering a number of items sorted;
storing and updating a count of items of the selected type placed in an item type container;
printing a receipt with a barcode;
reading the barcode on the receipt;
extracting the number of all item types received from the customer;
totaling the cash value thereof and for recording the cash amount paid out to the customer; and,
managing all item type container, including their present location, sort, the number of items in the container and the maximum number of items per container.
